(19) United States
(12) Patent Application Publication
(10) Pub. No.: US 2015/0063915 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Steven Ray Lovett, Marlow, OK (US); Aimee Kathleen Greening, Duncan, OK (US)

(73) Assignee: Halliburton Energy Services, Inc., Houston, TX (US)

(21) Appl. No.: 14/015,250

(22) Filed: Aug. 30, 2013

(51) Int. Cl. F16L 1/12

(52) U.S. Cl. CPC F16L 1/123
USPC 405/158

(57) ABSTRACT

A packer apparatus is configured to be arranged within and arrest a failure of a submerged pipeline. In one example, the packer apparatus includes first and second mandrels in axially moveable relation to one another, a brake connected to the second mandrel, and an elastomeric expansion boot circumferentially disposed around a portion of the first and second mandrels. The first mandrel is configured to move axially toward the second mandrel from a first position to a second position. In the second position, the first mandrel is configured to cause the expansion boot to be compressed axially between the first and second mandrels and expanded radially into engagement with an inner surface of the pipeline, and to cause the brake to move radially outward to engage the inner surface of the pipeline.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer.

FIG. 3A depicts a section view of the example packer of FIG. 2 in an unengaged state within a pipeline.

FIG. 3B depicts a section view of the example packer of FIGS. 2 in an engaged state within a pipeline.

FIG. 4 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer apparatus includes first and second mandrels in axially moveable relation to one another, a brake connected to the second mandrel, and an elastomeric expansion boot circumferentially disposed around a portion of the first and second mandrels. The first mandrel is configured to move axially toward the second mandrel from a first position to a second position. In the second position, the first mandrel is configured to cause the expansion boot to be compressed axially between the first and second mandrels and expanded radially into engagement with an inner surface of the pipeline, and to cause the brake to move radially outward to engage the inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline from ingress of water. The mechanisms for sealing and braking employed in a wet buckle packer can be actuated in a variety of ways. For example, electrical, hydraulic, or pneumatic supply lines can be run from the pipelay vessel on the surface to the packer. The wet buckle packer could also include a power source, e.g., a battery that could be used to actuate the seal and brake mechanisms. The packer or the system in which the device is employed can be configured to be actuated automatically using a variety of different sensors configured to detect water invasion into the pipeline.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

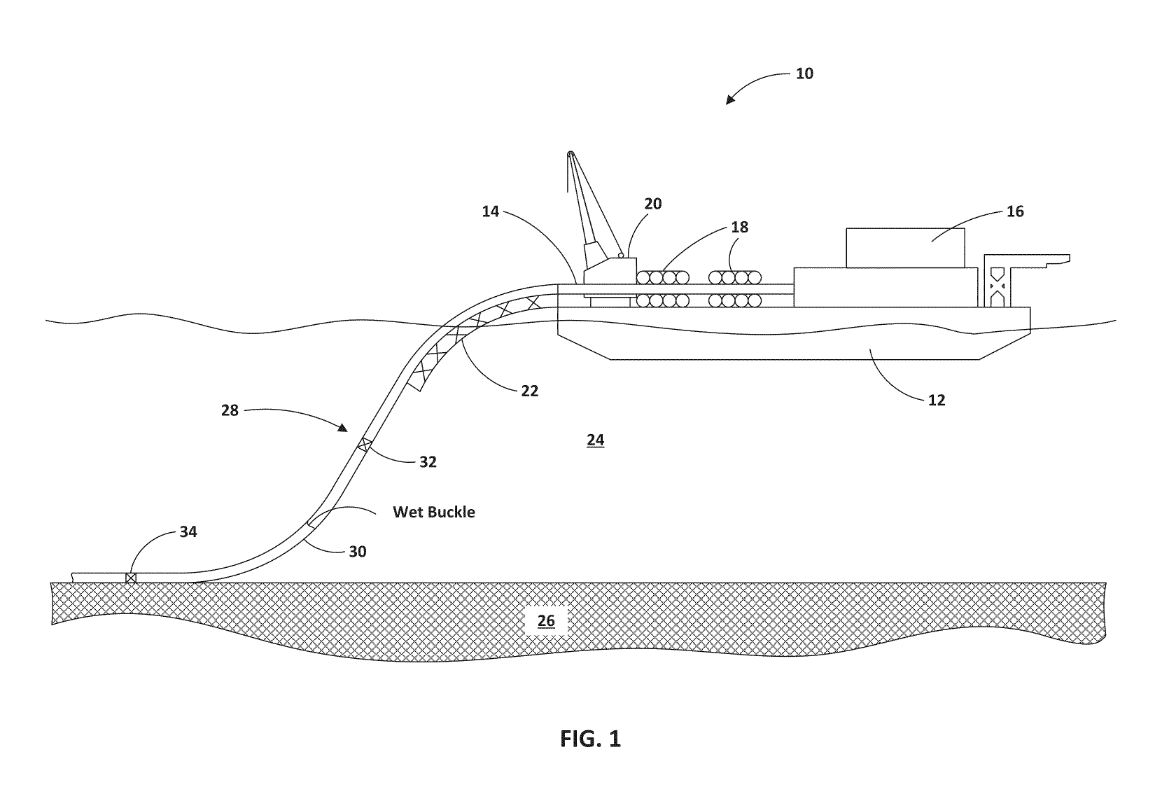

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger 22 to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in a manner such that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to top of the main pipeline 14 in which the piggy-back lines are received.

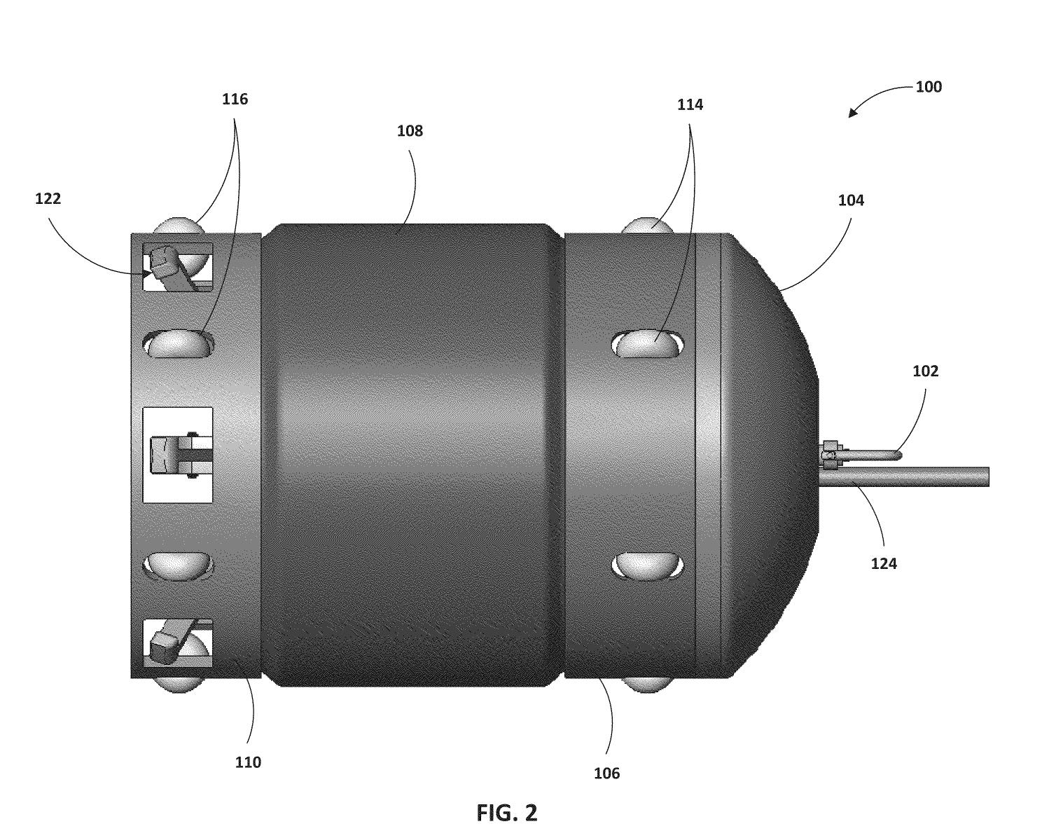

FIG. 2 depicts example wet buckle packer 100. Packer 100 includes a hoist ring 102, a cap 104, a first mandrel 106, an expansion boot 108, and second mandrel 110. Packer 100 is coupled to hoist line 112 by hoist ring 102, which is connected to cap 104; and cap 104 is connected to first mandrel 106. First mandrel 106 is moveably connected to second mandrel 110. Expansion boot 108 is disposed circumferentially around a portion of first mandrel 106 and second mandrel 110.

Packer 100 is configured to be deployed from a pipelay vessel down a submerged pipeline via hoist line 112. Packer 100 can be lowered into an already submerged pipeline or can be lowered along with a particular section of the pipeline as it is dropped to the sea floor. First mandrel 106 includes a number of freely rotating wheels 114 distributed around the outer circumference of mandrel 106. Additionally, second mandrel 110 includes a number of freely rotating wheels 116 distributed around the outer circumference of mandrel 110. Wheels 114 and 116 facilitate travel of packer 100 through the inner diameter of the submerged pipeline as packer 100 is lowered from the pipelay vessel and as otherwise may be needed during the pipe laying process.

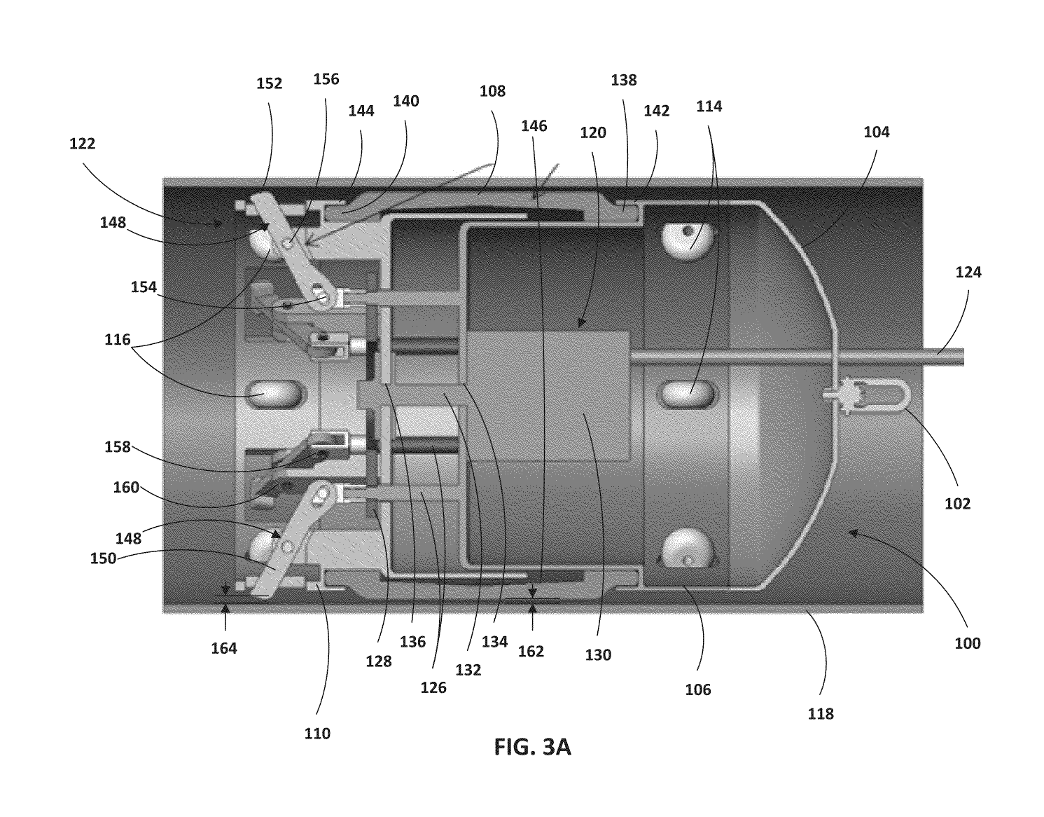

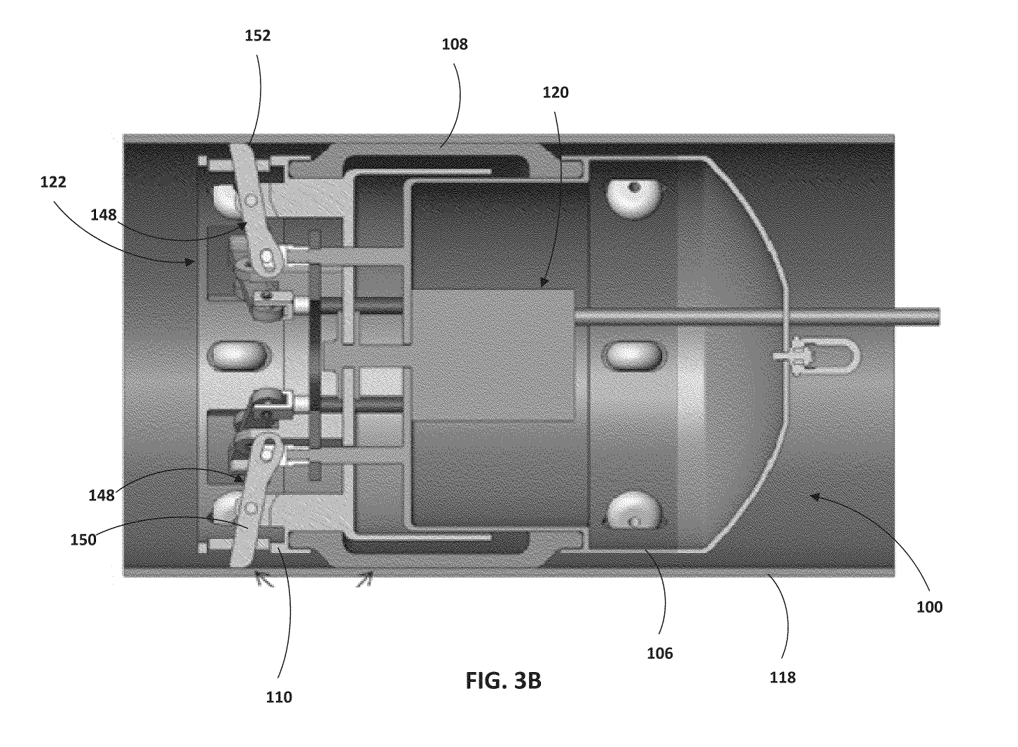

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline from being flooded with sea water, which is described in more detail with reference to FIGS. 3A and 3B.

Hoist line 112 extends from hoist ring 102 up to, for example, a hoist machine on a pipelay vessel. In some examples, packer 100 can include hoist rings on both ends of the device to deploy multiple packers within a pipeline in spaced, series relation within the pipeline. Packer 100 is configured to be arranged within the pipeline such that the end including cap 104 faces the region of the pipeline that is at risk of a wet buckle (or other failure). Thus, in the example of FIG. 1, one packer could be deployed within suspended pipe span 28 closer to the surface than the likely location of the wet buckle in the sagbend of the “S” curve and another packer could be deployed within pipeline 14 on the other side of the possible wet buckle location, e.g., somewhere along sea floor 26.

In this example, the packer deployed closer to the surface would be arranged within suspended pipe span 28 such that cap 104 faces down toward the likely location of the wet buckle in the sagbend. This upper packer could include a hoist line running from the end of the device including the second mandrel and another line running from the cap to the lower packer. The lower packer closer to sea floor 26 would be arranged within the pipeline such that the cap faces up toward the likely location of the wet buckle in the sagbend and the lower packer would be connected to the upper packer by the line coupled to the caps of each device.

FIGS. 3A and 3B depict section views of wet buckle packer 100 within pipeline 118. In FIG. 3A, packer 100 is unengaged with pipeline 118. In FIG. 3B, packer 100 is engaged with pipeline 118 to substantially seal the inner diameter of pipeline 118 from water invasion. As illustrated in the section views of FIGS. 3A and 3B, packer 100 includes actuator 120 and brake assembly 122 in addition to hoist ring 102, cap 104, first mandrel 106, expansion boot 108, and second mandrel 110. Actuator 120 and brake assembly 122 are connected to both first mandrel 106 and second mandrel 110. Supply line 124 is coupled to actuator 120.

Cap 104 and first mandrel 106 can be connected to one another in a variety of ways. In one example, cap 104 and first mandrel 106 are welded to one another. In another example, cap 104 and first mandrel 106 are connected to one another with a threaded connection including threading cap 104 into first mandrel 106 or threading first mandrel 106 into cap 104.

First mandrel 106 is configured to move axially relative to second mandrel 110. First mandrel 106 includes a number of posts 126 extending from one end of first mandrel 106 toward second mandrel 110. Posts 126 pass through holes in second mandrel 110. A ring-shaped plate 128 is connected to the end of posts 126 to connect first mandrel 106 to second mandrel 110. In this way, first mandrel 106 is able to move axially toward and away from second mandrel 110 as posts 126 pass through the respective holes in second mandrel 110. Plate 128 limits the axial distance first mandrel 106 can move away from second mandrel 110.

Actuator 120 is depicted schematically in FIGS. 3A and 3B, but generally includes housing 130 and shaft 132 movably connected to housing 130. Shaft 132 is configured to slide in and out of housing 130. Actuator 120 can be a variety of mechanical and electromechanical devices that are configured to be actuated to cause shaft 132 to move axially relative to housing 130. For example, actuator 120 can include a pneumatically or hydraulically actuated piston that drives shaft 132 with air or a hydraulic fluid supplied by supply line 124. In another example, actuator 120 includes an electrically activated solenoid that drives shaft 132. In another example, actuator 120 includes an electromagnetic piston that drives shaft 132 based on controlled electricity transmitted to packer 100 via supply line 124. In another example, actuator 120 includes an electric motor and screwjack, which can drive shaft 132 using electricity transmitted to packer 100 via supply line 124. In some cases, actuator 120 can be powered by a power source like a battery deployed with packer 100.

Housing 130 of actuator 120 is arranged within first mandrel 106. Shaft 132 extends axially from housing 130 through hole 134 in first mandrel 106 and hole 136 in second mandrel 110. The distal end of shaft 132 is connected to second mandrel 110. In one example, a nut and two washers are employed to fix the distal end of shaft 132 to second mandrel 110. However, shaft 132 could also be attached by other mechanisms, e.g., welded to second mandrel 110. In another example, second mandrel 110 could be fabricated with an integral shaft protruding axially toward first mandrel 106 and housing 130 of actuator 120.

Actuator 120 is configured to cause the distal end of shaft 132 to move axially relative to housing 130. As the distal end of shaft 132 changes axial position with respect to housing 130, first mandrel 106 is moved axially with respect to second mandrel 106.

Expansion boot 108 is an annular elastomeric boot that surrounds a portion of first mandrel 106 and second mandrel 110. First end 138 of expansion boot 108 is coupled to first mandrel 106. Second end 140 of expansion boot 108 is coupled to second mandrel 110. In particular, first end 138 is received within slot 142 extending circumferentially and axially in first mandrel 106 and second end 140 is received within slot 144 extending circumferentially and axially in second mandrel 110. In this manner, expansion boot 108 is sandwiched between first mandrel 106 and second mandrel 110.

As first mandrel 106 moves axially toward second mandrel 110, expansion boot 108 is compressed axially as slots 142 and 144 move closer to one another. As expansion boot 108 is compressed axially, boot 108 also radially expands into engagement with an inner surface of pipeline 118. As can be seen in FIG. 3A in which packer 100 is unengaged, inner surface 146 of expansion boot 108 is concave with a flattened “V” cross-sectional shape. The shape of inner surface 146 biases expansion boot 108 to move radially outward, instead of inward, when boot 108 is compressed axially between first mandrel 106 and second mandrel 110.

Brake assembly 122 includes a number of brake arms 148, which are distributed at different angularly disposed, circumferential positions around a longitudinal axis of packer 100. Brake arms 148 each include a respective link portion 150 and a respective pad 152 at the radially outward end of link 150. Link 150 is coupled to first mandrel 106 at moving pivot 154 and to second mandrel 110 at fixed pivot 156. In particular, the radially inward end of link 150 is pivotally connected to clevis 158 at moving pivot 154. Clevis 158 is connected to plate 128 of first mandrel 106. Link 150 is pivotally connected to clevis 160 between the radially inward end of the link and pad 152. Clevis 160 is connected to second mandrel 110.

As first mandrel 106 moves axially toward second mandrel 110, moving pivot 154 moves axially as the radially inward end of links 150 of brake arms 148 rotate relative to clevises 158. Axial movement of the radially inward end of links 150 cause the links to rotate about fixed pivot 156 at clevises 160. As links 150 rotate about fixed pivot 156, pads 152 move radially outward to engage the inner surface of pipeline 118, and set brake assembly 122. Pads 152 are illustrated with a relatively smooth surface finish. However, in other examples, pads 152 can include a texturized or otherwise contoured surface to improve braking performance. For example, pads 152 can include a saw-tooth profile or can be fabricated with a relatively rough surface finish.

Packer 100 can be actuated from the pipelay vessel on the surface of the sea in the event of a wet buckle in a submerged portion of pipeline 118, e.g., in the sagbend of the “S” curve formed by the suspended span of pipeline 118 as it descends to the sea floor. Packer 100 can include a sensor system that detects the invasion of water into the inner diameter of pipeline 118. In another example, the sensor system can be associated with a separate component and be communicatively coupled to packer 100. In another example, the sensor system can be associated with a separate component and be communicatively coupled to packer 100. In one example, the sensor system includes a water sensor including two spaced electrodes arranged within pipeline 118 such that water invading the pipeline would complete an electrical circuit of the sensor. In another example, a pressure sensor could be used to detect the invasion of water into the inner diameter of pipeline 118.

The sensor system communicatively coupled to packer 100 can provide a signal directly to control electronics included in actuator 120 or can transmit signals to a surface system, which, in turn, transmits control signals to actuator 120 via supply line 124. In the event water invasion is detected, actuator 120 causes the distal end of shaft 132 to move axially closer to housing 130. As the distal end of shaft 132 changes axial position with respect to housing 130, first mandrel 106 is moved axially toward second mandrel 110, which functions to axially compress and radially expand expansion boot 108. In the radially expanded state illustrated in FIG. 3B, expansion boot 108 is configured to substantially seal the inner diameter of pipeline 118 and thereby prevent or inhibit the laid pipeline from being flooded with water.

Actuator 120, in conjunction with radially expanding boot 108, also deploys brake assembly 122 to prevent or substantially inhibit movement of packer 100 within pipeline 118. For example, actuator 120 causes the distal end of shaft 132 to move axially closer to housing 130. As the distal end of shaft 132 changes axial position with respect to housing 130, first mandrel 106 is moved axially toward second mandrel 110. Movement of first mandrel 106 relative to second mandrel 110 translate moving pivots 154 axially as the radially inward end of links 150 of brake arms 148 rotate relative to clevises 158. Axial movement of the radially inward end of links 150 cause the links to rotate about fixed pivots 156 at clevises 160. As links 150 rotate about fixed pivots 156, pads 152 move radially outward into engagement with the inner surface of pipeline 118 to prevent or inhibit packer 100 from moving within the pipeline.

Although it is not illustrated in FIGS. 3A and 3B, packer 100 can include a locking mechanism that is configured to lock brake assembly 122 once it has been engaged. In one example, the locking mechanism includes a ratchet mechanism including one or more spring loaded pawls connected to second mandrel 110 and ratchet teeth inscribed in the outer surface of one or more of posts 126 of first mandrel 106. The ratchet mechanism can be configured to allow first mandrel 106 to move toward second mandrel 110, while preventing first mandrel 106 from moving axially away from second mandrel 110 after brake assembly 122 has been engaged. An example ratchet mechanism that could be configured for use with packer 100 is disclosed and described in described in U.S. application Ser. No. ______ (Atty. Docket No. 1880.517US1), filed Jul. ______, 2013 and entitled “METHODS AND APPARATUS FOR ARRESTING FAILURES IN SUBMERGED PIPELINES,” the entire contents of which are incorporated herein by reference.

Packer 100 is configured such that in the unengaged state illustrated in FIG. 3A the outer boundaries of packer 100 are offset from the inner surface of pipeline 118. The offset distance between packer 100 and the inner surface of pipeline 118 may differ at different points along the axial length of packer 100. For example, offset 162 between expansion boot 108 and the inner surface of the pipeline 118 is different than offset 164 between brake pads 152 and the inner surface of pipeline 118. In one example, packer 100 is designed such that offset 162 is approximately equal to 1/8 inch and offset 164 is greater than 1/8 inch. However, in other examples, offsets 162 and 164 can be larger or smaller depending on the clearance between packer 100 and pipeline 118 necessary to allow packer 100 to be deployed through pipeline 118 and the amount of radial expansion of expansion boot 108 and brake pads 152 that is provided when actuator 120 moves first mandrel 106 relative to second mandrel 110.

Although particular offset distances are described with reference to example packer 100, a packer in accordance with this disclosure will be constructed with a desired dimensional relationship with the dimensions of the pipeline in which the device is to be used. In one example configuration, a radial clearance of approximately 1/8 inch will separate the sealing element of the packer and the pipeline inner surface and a radial clearance of approximately 1/4 inch will separate the braking element of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configured packer 100 such that offset 162 between expansion boot 108 and the inner surface of the pipeline 118 is as small as possible while still allowing packer 100 to be deployed downpipe within pipeline 118. In practice, there may be a delay between the occurrence of a wet buckle to pipeline 118 and the resulting detection of the invasion of water caused by the wet buckle (depending in part on the location of a water sensor, if used), and activation of actuator 120 to cause expansion boot 108 and brake assembly 122 to engage the inner surface of pipeline 118. During the delay in actuation of packer 100 some water may pass through packer 100. Reducing offset 162 between expansion boot 108 and the inner surface of the pipeline 118 will reduce the amount of water that floods pipeline 118 before packer 100 is engaged and expansion boot 108 substantially seals the annulus of the pipeline.

As is illustrated in FIG. 3A, cap 104, first mandrel 106, and second mandrel 110 are hollow components. It may be desirable to design the components of packer 100 and other wet buckle packers in accordance with this disclosure as such in order to reduce the weight of the device. Packer 100 may be employed in relatively large pipelines. In one example, pipeline 118 has an inner diameter that is approximately equal to 40 inches. The large size of pipeline 118 necessitates a relatively large packer to seal the annulus of the pipeline. As such, in one example, packer 100 may weigh on the order of approximately 10,000 pounds. In such situations, removing as much material from cap 104, first mandrel 106, second mandrel 110, and other components of packer 100 can have a significant impact on the weight of the device.

The overall weight of packer 100 also affects the amount of load on hoist line 112 and, as such, the amount of work required by the hoist machine operating hoist line 112. As such, reducing the weight of packer 100 can also reduce the cost and complexity of deploying packer 100 via hoist line 112.

The forces encountered by packer 100 in the event of a wet buckle of pipeline 118 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

It is also noted that the forces encountered by different portions of packer 100 may differ significantly. For example, portions of packer 100 may be partially or substantially pressure balanced because water introduced into pipeline 118 is allowed to enter parts of packer 100. In such situations, the pressure of the water is balanced on particular portions of packer 100. For example, water may be allowed to enter portions of packer 100 such that the water pressure is balanced on either side of a wall of one or more of cap 104, first mandrel 106, and second mandrel 110. In one example, pressure balancing of packer 100 could include providing flow port holes in cap 104 and/or first mandrel 106, in which case it may be necessary to seal hole 134. In some examples, therefore, packer 100 may be designed to allow pressure balancing of some portions of the device such that the wall thicknesses of different portions of cap 104, first mandrel 106, second mandrel 110, and other components of packer 100 may differ significantly depending on the amount of pressure/force encountered in the event of a wet buckle.

In order to engage packer 100 including radially expanding expansion boot 108 and setting brake assembly 122, actuator 120 is configured to generate a range of setting forces. In one example, actuator 120 is configured to generate a setting force approximately equal to 60,000 pounds to substantially seal pipeline 118 with expansion boot 108 and prevent or inhibit movement of packer 100 with brake assembly 122. In other examples, actuator 120 is configured to generate a setting force that is less or greater than 60,000 pounds. For example, in a smaller diameter pipe approximately equal to 7 inches, actuator 120 is configured to generate a setting force approximately equal to 12,000 pounds.

A variety of materials can be used to fabricate the components of packer 100 including, e.g., metals, plastics, elastomers, and composites. For example, cap 104, first mandrel 106, expansion boot 108, and second mandrel 110 can be fabricated from a variety of different types of steel or aluminum. Expansion boot 108 can be fabricated from a variety of elastomeric materials including rubber. In one example, expansion boot 108 is fabricated from a nitrile rubber. At the sea floor, packer 100 may encounter temperatures as low as 32 degrees Fahrenheit (0 degrees Celsius). As such, expansion boot 108 may need to be fabricated from elastomers that can withstand relatively low temperatures without significantly affecting the material properties of boot 108. For example, expansion boot 108 may need to be fabricated from elastomers that can withstand relatively low temperatures without causing boot 108 to become too hard, stiff and/or brittle such that boot 108 is incapable of sufficiently sealing the annulus of pipeline 118. The components of packer 100 can be fabricated using a variety of techniques including, e.g., machining, injection molding, casting, and other appropriate techniques for manufacturing such parts.

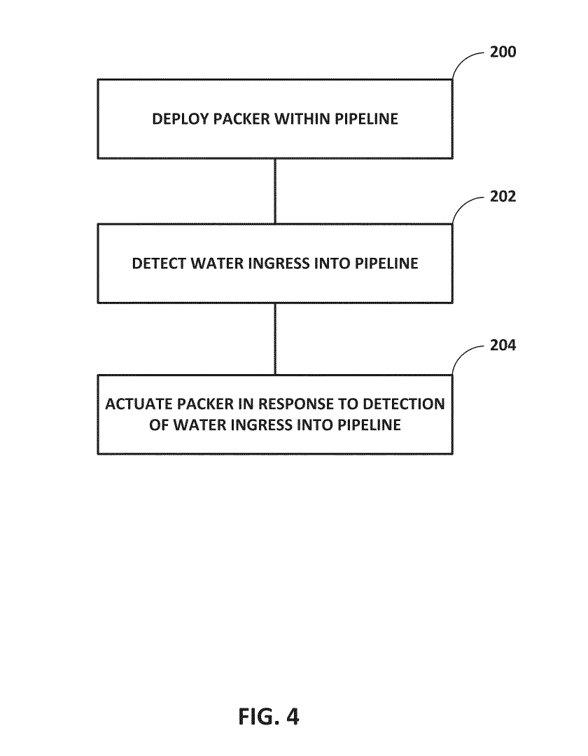

FIG. 4 is a flowchart depicting an example method of arresting a wet buckle of a submerged pipeline. The method includes deploying a packer apparatus within the pipeline (200), detecting water ingress into the pipeline (202), and actuating the packer apparatus in response to the detection of the water ingress into the pipeline (204). In one example, the packer includes first and second mandrels in axially moveable relation to one another, a brake connected to the second mandrel, and an elastomeric expansion boot circumferentially disposed around a portion of the first and second mandrels.

The packer apparatus can be deployed into the pipeline via a hoist line connected to a hoist machine on a pipelay vessel. Detection of water ingress into the pipeline can include sensing water invasion into the inner annulus of the pipeline with a sensor included in or separate from the packer apparatus. In one example, the packer can include a sensor system that detects the invasion of water into the annulus of the pipeline. The sensor system communicatively coupled to the packer can provide a signal directly to control electronics included in an actuator of the packer or can transmit signals to a surface system, which, in turn, transmits control signals to the actuator via a supply line. In the event water invasion is detected, the actuator of the packer can trigger actuation of the device.

Actuating the packer apparatus can include transmitting signals from the pipelay vessel on the surface to the packer via the supply line connected to the actuator of the packer. The actuator can be configured to move the first mandrel axially toward the second mandrel from a first position to a second position. In the second position, the first mandrel causes the expansion boot to be compressed axially between the first and second mandrels and expanded radially into engagement with an inner surface of the pipeline and the first mandrel causes the brake to move radially outward to engage the inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the location of the wet buckle (or other failure). In such examples, both packers can be actuated to seal the region of the pipeline between the packers and including the location of the failure.

Various examples have been described. These and other examples are within the scope of the following claims.

I claim:

1. A packer apparatus configured to be arranged within and arrest a failure of a submerged pipeline, the packer apparatus comprising:
first and second mandrels in axially moveable relation to one another;
a brake connected to the second mandrel; and
an elastomeric expansion boot circumferentially disposed around a portion of the first and second mandrels,
wherein the first mandrel is configured to move axially toward the second mandrel from a first position to a second position, and wherein, in the second position, the first mandrel is configured to cause:
the expansion boot to be compressed axially between the first and second mandrels and expanded radially into engagement with an inner surface of the pipeline; and
the brake to move radially outward to engage the inner surface of the pipeline.

2. The apparatus of claim 1, further comprising an actuator configured to cause the first mandrel to move axially toward the second mandrel from the first position to the second position.

3. The apparatus of claim 2, wherein the actuator comprises at least one of a pneumatic, hydraulic, electrical, electromechanical, and electromagnetic actuator.

4. The apparatus of claim 1, wherein, in the first position, the first mandrel is configured to cause the expansion boot to be in a radially unexpanded state and the brake to be unengaged with the inner surface of the pipeline.

5. The apparatus of claim 1, further comprising a plurality of wheels rotatably connected to the first mandrel and disposed at different angularly disposed, circumferential positions around a longitudinal axis of packer apparatus.

6. The apparatus of claim 1, further comprising a plurality of wheels rotatably connected to the second mandrel and disposed at different angularly disposed, circumferential positions around a longitudinal axis of packer apparatus.

7. The apparatus of claim 1, wherein the expansion boot comprises a nitrile rubber.

8. The apparatus of claim 1, wherein the expansion boot comprises an annulus comprising a radially inner surface, at least a portion of which comprises a “V” shaped profile.

9. The apparatus of claim 8, wherein a first end of the expansion boot is received within a circumferentially and axially extending slot in the first mandrel and a second end of the expansion boot is received within a circumferentially and axially extending slot of the second mandrel.

10. The apparatus of claim 1, wherein the brake comprises a plurality of brake arms disposed at different angularly disposed, circumferential positions around a longitudinal axis of the packer apparatus.

11. The apparatus of claim 10, wherein each brake arm comprises:
a link portion; and
a pad arranged adjacent a first end of the link portion,
wherein the link portion is pivotally connected to the first mandrel at a second end and pivotally connected to the second mandrel between the first and second ends.

12. The apparatus of claim 1, further comprising a sensor configured to detect ingress of water into the pipeline.

13. A system for arresting a failure of a submerged pipeline,
the system comprising:
a hoist machine;
a packer apparatus configured to be arranged within the submerged pipeline, wherein the packer apparatus comprises:
first and second mandrels in axially moveable relation to one another;
a brake connected to the second mandrel; and
an elastomeric expansion boot circumferentially disposed around a portion of the first and second mandrels,
wherein the first mandrel is configured to move axially toward the second mandrel from a first position to a second position, and wherein, in the second position, the first mandrel is configured to cause:
the expansion boot to be compressed axially between the first and second mandrels and expanded radially into engagement with an inner surface of the pipeline; and
the brake to move radially outward to engage the inner surface of the pipeline; and
a hoist line comprising a first end operatively connected to the hoist machine and second end connected to the packer apparatus.

14. The system of claim 13, wherein the packer apparatus comprises an actuator configured to cause the first mandrel to move axially toward the second mandrel from the first position to the second position.

15. The system of claim 13, wherein, in the first position, the first mandrel is configured to cause the expansion boot to be in a radially unexpanded state and the brake to be unengaged with the inner surface of the pipeline.

16. The system of claim 13, wherein the packer apparatus comprises a plurality of wheels rotatably connected to the first mandrel and disposed at different angularly disposed, circumferential positions around a longitudinal axis of packer apparatus.

17. The system of claim 13, further comprising a plurality of wheels rotatably connected to the second mandrel and disposed at different angularly disposed, circumferential positions around a longitudinal axis of packer apparatus.

18. The system of claim 13, wherein the expansion boot comprises a nitrile rubber.

19. The system of claim 13, wherein the expansion boot comprises an annulus comprising a radially inner surface, at least a portion of which comprises a “V” shaped profile.

20. The system of claim 13, wherein the brake comprises a plurality of brake arms disposed at different angularly disposed, circumferential positions around a longitudinal axis of packer apparatus.

21. The system of claim 20, wherein each brake arm comprises:
a link portion; and
a pad arranged adjacent a first end of the link portion,
wherein the link portion is pivotally connected to the first mandrel at a second end and pivotally connected to the second mandrel between the first and second ends.

22. The system of claim 13, further comprising a sensor configured to detect ingress of water into the pipeline.

23. A system for arresting a failure of a submerged pipeline,
the system comprising:
a first packer apparatus configured to be disposed at a first position within the pipeline; and
a second packer apparatus configured to be disposed at a second position within the pipeline,
wherein at least one of the first and the second packer apparatus comprises:
first and second mandrels in axially moveable relation to one another;
a brake connected to the second mandrel; and
an elastomeric expansion boot circumferentially disposed around a portion of the first and second mandrels,
wherein the first mandrel is configured to move axially toward the second mandrel from a first position to a second position, and wherein, in the second position, the first mandrel is configured to cause:
the expansion boot to be compressed axially between the first and second mandrels and expanded radially into engagement with an inner surface of the pipeline; and
the brake to move radially outward to engage the inner surface of the pipeline.

24. A method of arresting a failure of a submerged pipeline,
the method comprising:
deploying a packer apparatus within the pipeline, wherein the packer apparatus comprises:
first and second mandrels in axially moveable relation to one another;
a brake connected to the second mandrel; and
an elastomeric expansion boot circumferentially disposed around a portion of the first and second mandrels;
detecting ingress of water into the pipeline;
actuating the packer apparatus to move the first mandrel axially toward the second mandrel from a first position to a second position, and wherein, in the second position, the first mandrel causes the expansion boot to be compressed axially between the first and second mandrels and expanded radially into engagement with an inner surface of the pipeline and the first mandrel causes the brake to move radially outward to engage the inner surface of the pipeline.
